(19) United States
(12) Patent Application Publication
(10) Pub. No.: US 2024/0282935 A1
(43) Pub. Date: Aug. 22, 2024

(54) ANODE MATERIAL, BATTERY AND METHOD FOR PRODUCING AN ANODE MATERIAL

(71) Applicant: Volkswagen Aktiengesellschaft, Wolfsburg (DE)

(72) Inventor: Jaekyung SUNG, Ulsan (KR)

(73) Assignee: Volkswagen Aktiengesellschaft, Wolfsburg (DE)

(21) Appl. No.: 18/644,983

(22) Filed: Apr. 24, 2024

Related U.S. Application Data
(63) Continuation of application No. PCT/EP2022/079355, filed on Oct. 21, 2022.

(30) Foreign Application Priority Data
Oct. 25, 2021 (DE) 10 2021 211 974.3

(51) Int. Cl. H01M 4/36; H01M 4/02; H01M 4/04; H01M 4/38; H01M 4/583

(52) U.S. Cl. CPC H01M 4/366; H01M 4/0421; H01M 4/386; H01M 4/583; H01M 2004/021; H01M 2004/027

(57) ABSTRACT

An anode material having a number of particles. A respective particle has a core and a sheath surrounding the core. The sheath contains silicon, carbon and nitrogen. Also provided is a battery and a method for producing an anode material.

This nonprovisional application is a continuation of International Application No. PCT/EP2022/079355, which was filed on Oct. 21, 2022, and which claims priority to German Patent Application No. 10 2021 211 974.3, which was filed in Germany on Oct. 25, 2021, and which are both herein incorporated by reference.

### BACKGROUND OF THE INVENTION

### Field of the Invention

The invention relates to an anode material, a battery including an anode made of such an anode material, and a method for producing the anode material.

### Description of the Background Art

An anode material is used to produce an anode, which is part of a battery. Batteries are already used in an electric vehicle, for example, in which they provide electrical energy for an electric drive train. One example of a battery is a lithium-ion battery, in which silicon or carbon, for example, is used as the anode material.

A battery includes one or more cells, and each cell has two electrodes, namely, an anode and a cathode. The performance of the battery and of each individual cell also depends in particular on the electrodes and the materials used. For example, it is possible to use a combination of silicon particles and carbon as anode material. The use of silicon results in a particularly high energy density. However, the use of pure silicon in the anode material has several disadvantages. Silicon has poor electrical conductivity, and conversely is correspondingly electrically insulating. In addition, silicon undergoes a drastic change in volume during lithiation, and is susceptible to permanent lithium trapping as well as unstable, continuous formation of a solid electrolyte interphase (SEI) on the surface of the silicon. Furthermore, pure silicon is at risk of mechanical disintegration (fracture or pulverization, for example).

WO 2020/260332 A1, which corresponds to US 2022/0246906 describes an anode comprising particles having a silicon-based core that is surrounded by two carbon coatings having different densities.

US 2010/0310941 A1 describes a method for producing an anode material. Carbon nanotubes (CNTs) are initially produced, and are subsequently coated with silicon.

### SUMMARY OF THE INVENTION

It is therefore an object of the invention to provide an improved anode material. The intent is to avoid or at least reduce, to the greatest extent possible, one or more of the disadvantages stated at the outset. Furthermore, a battery including such an anode material as well as a method for producing the anode material are provided.

The object is achieved according to the invention by an anode material, by a battery, and by a method. The statements regarding the anode material also analogously apply to the battery and to the method, and vice versa.

The anode material according to the invention can be designed for use in an anode of a battery. The battery can be a lithium-ion battery; in the following discussion it is also assumed, without limiting generality, that the battery is a lithium-ion battery. The anode material contains a number of particles. The anode material typically comprises a plurality of particles. The number of particles per gram of anode material is a function in particular of the size of the individual particles. A single particle preferably has an average diameter of 50 nm to 50 μm, particularly preferably 1 μm to 20 μm.

A respective particle has a core, and a shell that surrounds the core, in particular directly, i.e., without a space or intermediate layers in between. The core itself is preferably solid, i.e., not hollow. The shell contains silicon, carbon, and nitrogen. This is preferably understood to mean that the shell is made exclusively of silicon, carbon, and nitrogen and/or compounds thereof, and that accordingly, other substances, materials, and/or elements are not present. The shell preferably contains no further elements besides the stated elements silicon, nitrogen, and carbon. Accordingly, the shell is also referred to as an SiCxNy layer, i.e., as a layer made of silicon in combination with carbon and nitrogen, where x and y indicate the substituent numbers of carbon or nitrogen relative to the silicon. In an example, the substituent number x=0.515 and the substituent number y=0.046. This corresponds to a composition of Si:C:N=64 at %:33 at %:3 at %. Thus, the carbon fraction is generally much greater (i.e., at least by a factor of 5) than the nitrogen fraction, and overall, silicon typically constitutes the largest fraction. The stated composition does not necessarily have to be adhered to, and other suitable substituent numbers result in particular from varying the substituent numbers stated above by a factor of 0.5 to 2.

In the present case, the silicon of the shell is used in particular as an active material which correspondingly absorbs and releases lithium ions during charging and discharging (referred to as lithiation and delithiation, respectively). The anode material is thus a silicon-based anode material.

The described anode material based on SiCxNy has a particularly high energy density of in particular >1000 mAh/g, and allows particularly fast charging and discharging of a battery that contains such an anode material.

The silicon in the shell (more precisely, at least a first portion of the silicon in the shell) preferably forms a plurality of nanoparticles. In particular, the nanoparticles are in each case made exclusively of silicon, and therefore are also referred to as silicon nanoparticles.

“Nanoparticles” can be understood in particular to mean particles having spatial dimensions (i.e., length, width, height, or diameter) of approximately 1 nm to several hundred 100 nm, and in each case <1 μm. In the present case, the nanoparticles preferably have an average diameter in the range of 0.5 nm to 5 nm, particularly preferably 1 nm to 2 nm, and thus are comparatively small nanoparticles. The dimensions of a particular particle, viewed in the three spatial directions, are not necessarily identical, and instead may differ from one another, for example by up to one order of magnitude.

It must be emphasized that the stated nanoparticles are somewhat different than the particles with a core and shell described above. Namely, the nanoparticles are part of the shell, so that the particles of the anode material are consequently larger than the nanoparticles, typically by one or more orders of magnitude, and the shell contains a plurality of nanoparticles. In an example, the shell then has a layer thickness in the range of 100 nm to 200 nm, and particularly preferably has an average layer thickness of 150 nm.

The silicon in the shell (more precisely, a second portion of the silicon in the shell) together with the carbon and the nitrogen can form an inactive matrix in which the nanoparticles are embedded. The nanoparticles are an active material, namely, contain silicon, which is lithiated and delithiated during a cycle. In contrast, the inactive matrix is an inactive material which correspondingly is not lithiated or delithiated during a cycle.

The invention initially proceeds from the observation that there is a basic need to increase the energy density of batteries while simultaneously limiting the installation space. This is particularly relevant for electrically driven vehicles of any type. For lithium-ion batteries, it is possible in principle to use carbon or silicon as anode material. However, graphite (a configuration of carbon), for example, has a low energy density, having a theoretical maximum of only 372 mAh/g. In contrast, for silicon the energy density is an order of magnitude greater, and has a theoretical maximum of 3579 mAh/g. Therefore, the use of silicon is initially advantageous in principle. However, silicon also has several disadvantages, in particular a significant change in volume during lithiation and delithiation (i.e., during charging and discharging, or during a cycle) as well as low electrical conductivity. This results in further problems, in particular irreversible lithium trapping, mechanical disintegration of the anode material in the form of fractures or pulverization, electrical insulation, and unstable, continuous formation of a solid electrolyte interphase (SEI). Overall, this results in poor electrochemical properties, in particular a large, irreversible loss of capacity in particular during the first cycle (i.e., charge/discharge cycle), and for long cycles, an increase in the internal electrical resistance, poor cycle efficiency, and a drastic decrease in capacity with increasing number of cycles.

Various approaches are conceivable and beneficial for reducing the disadvantages in the use of silicon. In an example, the extent or size of the silicon is adapted, in particular reduced. For example, as advantageously described above, silicon in the form of nanoparticles is used to reduce mechanical load and its effects (fractures and pulverization). In addition, faster diffusion of lithium as well as faster electron transfer are achieved in this way. It is likewise advantageous to coat the silicon, in general the active material, with a material having the highest possible electrical conductivity, thus correspondingly improving the overall electrical conductivity and likewise reducing side reactions at the surface of the silicon (and of the active material in general), which further reduces the risk of mechanical damage. It is also particularly advantageous to dilute the silicon, which with respect to the lithium is an active material, with a material that is inactive with respect to the lithium. The change in volume during lithiation and delithiation is thus reduced, since the inactive material does not correspondingly make a contribution. The dilution of the active silicon with an inactive material also potentially improves the overall electrical conductivity of the anode material. Specialized “void space engineering” is also advantageous, i.e., intentional creation of voids in the anode material which accommodate a change in volume and also limit growth of the solid electrolyte interphase. Similarly as for the above-described combination of active and inactive material, it is also advantageous to use specialized compounds, which as active material contain carbon, for example in the form of graphite. Such an anode material may generally be calendered particularly well, thus achieving a high electrode density.

Of the approaches stated above, in the present case the coating of the active material, the combination of the active material with an inactive material, and the use of specialized compounds are regarded as particularly promising and advantageous. As a result, in particular the use of silicon nanoparticles taken alone, and void space engineering are disadvantageous for reduced energy density, and a corresponding battery requires more installation space for the same energy density. In addition, void space engineering results in a large, irreversible loss of capacity during the first cycle. This may be avoided to a certain extent by using silicon oxide (i.e., SiOx, where x indicates the substituent number of oxygen relative to the silicon); however, silicon oxide has other disadvantages, as described in greater detail below. For example, it is advantageous to embed silicon nanoparticles in an inactive matrix made of silicon oxide in order to suppress, at least in part, the change in volume during charging and discharging. Alternatively or additionally, the inactive matrix contains carbon, for example graphite. Use of a compound composed of silicon and carbon is similarly advantageous.

Although an inactive matrix (i.e., an inactive material for embedding of the active material) is in principle advantageous as part of the anode material, it also results in disadvantages regarding the electrochemical properties. For example, when silicon oxide is used, Li2O and Li4SiO4 may be formed in side reactions, resulting in reduced Coulomb efficiency. This process is also irreversible. In the case of silicon carbide, for the production silicon nanoparticles are produced by mechanical grinding, for example; however, silicon oxide then generally forms on the surface of the silicon nanoparticles, with the stated disadvantages. In addition, the inactive matrix made of carbon is brittle due to the grinding, and has very low mechanical strength; i.e., it fractures easily during repeated charging/discharging.

Prelithiation of the anode material prior to manufacture of the battery comes into consideration as a further approach to compensate for the loss of lithium in the first cycle. However, the use of lithium is generally problematic and hazardous, which is only exacerbated by the increased quantity.

In the present case, it has been observed that embedding silicon nanoparticles in silicon carbide (SiCx) or silicon nitride (SiNx) is particularly advantageous, and results in a particularly suitable anode material. In an example, such an anode material is produced by chemical gas phase deposition, and thus, thermal decomposition, of a gas mixture which preferably contains monosilane in combination with ethylene (for silicon carbide) or ammonia (for SiNx). Such an anode material has an advantageously reduced quantity of irreversible reaction products, as well as a higher reversible capacity. An anode material containing silicon carbide as inactive matrix is also characterized by a particularly high mechanical strength, in particular in comparison to pure carbon, and also has a high electrical conductivity. In contrast, an anode material containing silicon nitride as inactive matrix is characterized by a particularly high ion conductivity, in particular in comparison to silicon oxide or pure carbon, and also has improved electrochemical behavior.

Similarly, in the present case carbon and nitrogen are combined with silicon to form an anode material, which then combines the stated advantages of these two elements in conjunction with silicon. The carbon and the nitrogen in particular take part in the formation of an inactive matrix in which at least a portion of the silicon, preferably as nanoparticles, is embedded as active material. In an example, for this purpose carbon, nitrogen, and silicon in particular form various compounds, which then together form the inactive matrix. The inactive matrix can be formed from a plurality of regions made of nitrogen-doped carbon (i.e., the carbon forms a lattice that sporadically contains nitrogen), silicon nitride (SiN), silicon carbide (SiC), and/or silicon carbonitride (SiCN), particularly preferably made of all these compounds. Experiments have demonstrated that an anode material having such an inactive matrix based on SiCxNy, compared to the use of only SiNx or only SiCx, for example, has improved cycle stability, in a half cell configuration as well as in a full cell configuration. In addition, the anode material based on SiCxNy has improved electrochemical properties compared to the other stated configurations.

Apart from the shell, previously described in detail, the particles of the anode material also may have a core. In the present case, its composition is of less importance, but an example is advantageous in which the core is made exclusively of carbon. Also advantageous is an example in which the core is solid. In general, the carbon in particular forms a framework for the shell and holds and/or stabilizes it. A core made of carbon is therefore also referred to as a carbon-containing framework, regardless of whether the core is solid. The core preferably has an average diameter that is up to two orders of magnitude greater than the layer thickness of the shell. In an example, the core has an average diameter of 500 nm to 50 μm, and particularly preferably has an average diameter of 1 μm to 10 μm, in particular 5 μm.

The particles in each case can have a casing, made of carbon, in which the core and the shell are enclosed. The core is thus double-coated, in a manner of speaking, with the shell forming a first, inner layer and the casing made of carbon forming a second, outer layer. The casing preferably directly adjoins the shell. The casing made of carbon is used in particular as filler material between the various shells (and the cores surrounded by same), and spaces the shells apart from one another. The casings of the particles are advantageously grown and/or joined together, and then form a network in which the cores with shells are embedded, analogously to an individual particle in which the nanoparticles are embedded in its inactive matrix.

Various examples are conceivable and suitable for the particular form of the core and shell. The shell can follow an outer contour of the core, and has essentially the same layer thickness (i.e., with a tolerance <5%) at each point. The shell thus forms a uniform covering for the core. The core and the shell of a particular particle, taken together, can have a plate-or rod-shaped design. However, a spherical shape of the core and shell is also suitable.

A battery according to the invention has an anode that is produced from an anode material as described above. The battery is preferably a lithium-ion battery. The battery is preferably used to supply power to an electric drive of a vehicle.

A method according to the invention for producing an anode material, in particular an anode material as described above is provided. The anode material contains a number of particles, a respective particle having a core, and a shell that surrounds the core. The shell is produced by gas phase deposition, in particular chemical vapor deposition (CVD), using a silicon-containing gas, a carbon-containing gas, and a nitrogen-containing gas. The silicon-containing gas is preferably monosilane (SiH4). The carbon-containing gas is preferably ethene (C2H4). The nitrogen-containing gas is preferably ammonia (NH3). All three gases are suitably applied at the same time, i.e., in a single method step, and in particular not separately or in different method steps. The precise composition and form of the anode material, in particular of the particles, may be set in detail via the relative ratios of the volumetric flows of the three gases with respect to one another and the quantity of gas used for each. Further parameters for influencing the production and the resulting anode material are temperature and time during production, as well as size and morphology of the cores of the anode material. The optimal parameters may be different, depending on the particular application for the anode material. The optimal parameters for the production are advantageously determined in each case by experiments.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a detail of an anode material,

FIG. 2 shows a battery,

FIG. 3 shows a portion of a shell of a particle of the anode material from FIG. 1,

FIG. 4 shows the voltage profile of three half cells,

FIG. 5 shows the specific capacity and Coulomb efficiency of the three half cells from FIG. 4,

FIG. 6 shows the capacity retention ratio of the three half cells from FIG. 4,

FIG. 7 shows the capacity retention ratio for three full cells, and

FIG. 8 shows chemical gas phase deposition for producing the anode material from FIG. 1.

### DETAILED DESCRIPTION

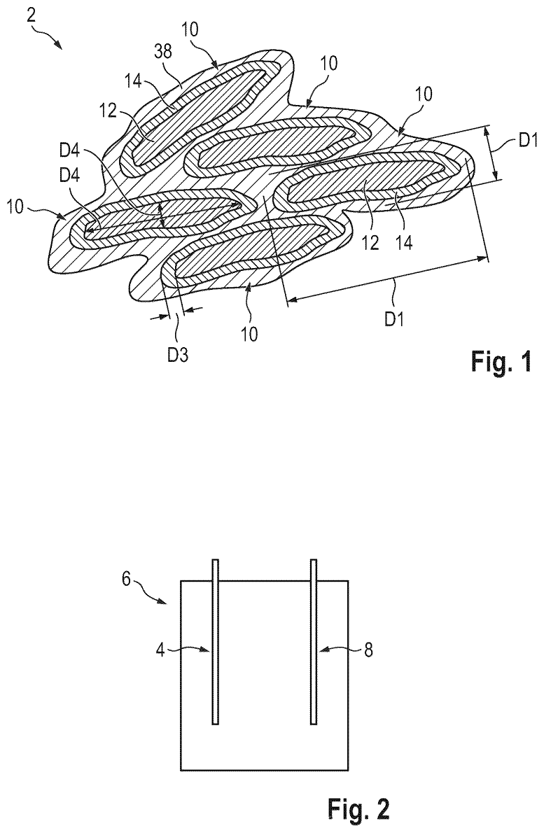

FIG. 1 illustrates a detail of anode material 2 that is designed for use in an anode 4 of a battery 6, for example as illustrated in FIG. 2. The battery 6 also has a cathode 8, and is a lithium-ion battery here by way of example. The anode material 2 contains a number of particles 10. The anode material 2 typically comprises a plurality of particles 10. In the example shown, a single particle 10 has an average diameter of 50 nm to 50 μm, which results as the average value of the various diameters D1.

As is apparent from FIG. 1, a respective particle 10 has a core 12, and a shell 14 that directly surrounds the core 12. The shell 14 contains silicon, carbon, and nitrogen, and in the present case is made exclusively of silicon, carbon, and nitrogen and/or compounds thereof. The shell 14 contains no further elements besides the stated elements silicon, nitrogen, and carbon. Accordingly, the shell 14 is also referred to as an SiCxNy layer, i.e., as a layer made of silicon in combination with carbon and nitrogen.

In the present case, the silicon of the shell 14 is used as an active material which correspondingly absorbs and releases lithium ions during charging and discharging (referred to as lithiation and delithiation, respectively). The anode material 2 is thus a silicon-based anode material 2.

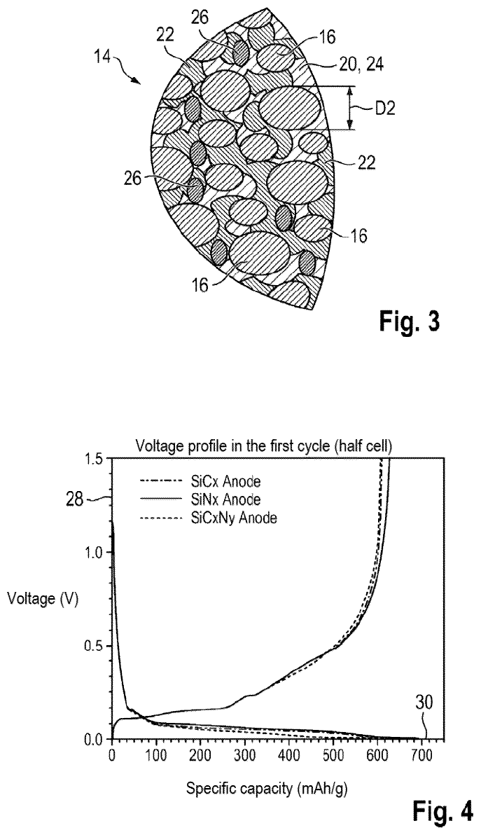

In the example shown, the silicon in the shell 14 forms a plurality of nanoparticles 16. This is apparent in FIG. 3, which shows a detail of FIG. 1 in an enlarged illustration, so that the shell 14 of one of the particles 10 is discernible in detail. The nanoparticles 16 in each case are made exclusively of silicon, and therefore are also referred to as silicon nanoparticles. In the present case, the nanoparticles 16 have an average diameter in the range of 1 nm to 2 nm, which results as the average value of possibly different diameters D2.

The nanoparticles 16 are part of the shell 14, so that the particles 10 of the anode material 2 are consequently larger than the nanoparticles 16, typically by one or more orders of magnitude. The shell 14 has a layer thickness D3 in the range of 100 nm to 200 nm, for example.

The silicon in the shell 14 together with the carbon and the nitrogen forms an inactive matrix 18 in which the nanoparticles 16 are embedded. The nanoparticles 16 are an active material, namely, contain silicon, which is lithiated and delithiated during a cycle. In contrast, the inactive matrix 18 is an inactive material which correspondingly is not lithiated or delithiated during a cycle.

As stated above, in the present case carbon and nitrogen are combined with silicon to form an anode material 2. The carbon and the nitrogen take part in the formation of the inactive matrix 18 in which at least a portion of the silicon is embedded as active material, here as nanoparticles 16. In the example shown, for this purpose carbon, nitrogen, and silicon form various compounds, which then together form the inactive matrix 18. In the present case, the inactive matrix 18 is formed from a plurality of regions made of nitrogen-doped carbon 20, silicon nitride 22, silicon carbide 24, and silicon carbonitride 26. In FIG. 3, for the sake of clarity an explicit distinction is not made between nitrogen-doped carbon 20 and silicon carbide 24, and those regions including carbon and/or compounds containing carbon, apart from SiCN, are combined for simplicity.

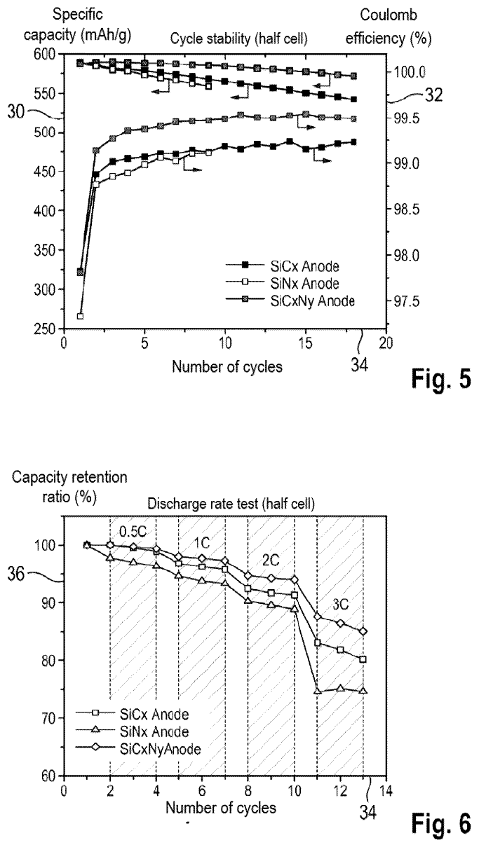

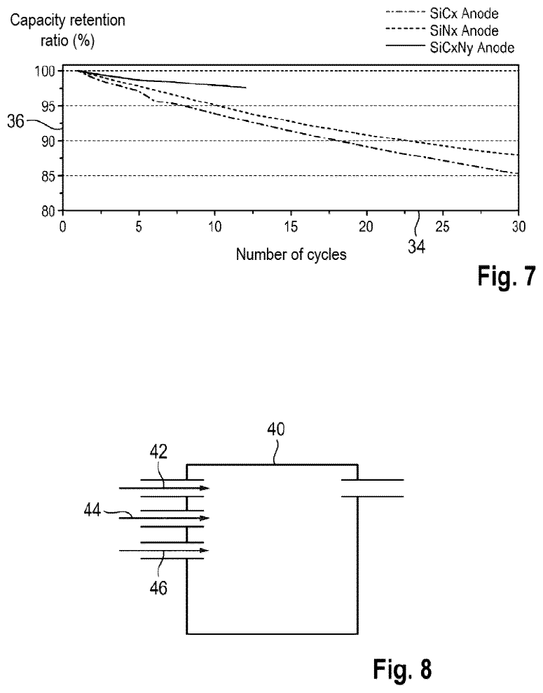

FIGS. 4 through 7 show results of experiments that have demonstrated that an anode material 2 containing an inactive matrix 18 based on SiCxNy, in comparison to the use of only SiNx or only SiCx, has improved cycle stability, in a half cell configuration (see FIGS. 4 through 6) as well as in a full cell configuration (see FIG. 7). FIG. 4 shows the voltage profile of three half cells, namely, anodes made of SiNx, SiCx, and SiCxNy, in the first cycle. The voltage 28 (in V) of the particular half cell is indicated as a function of the specific capacity 30 (in mAh/g). FIG. 5 shows the specific capacity 30 (in mAh/g) on the left side and the Coulomb efficiency 32 (in %) on the right side, as a function of the number of cycles 34 (dimensionless) for the three half cells. FIG. 6 shows the result of a discharge rate test for the three half cells. The capacity retention ratio 36, i.e., the capacity retention in comparison to the first cycle, is shown as a function of the number of cycles 34, wherein the charging current increases with progressive cycles (the capacity retention ratio corresponds in particular to the ratio of the specific capacity in a certain cycle to the original specific capacity in the first cycle, and thus indicates how much of the original capacity retention still remains after a certain number of cycles). Thus, the charging current for the first cycle is 0.2 C (C=A/Ah), for the second through fourth cycles is 0.5 C, for the fifth through seventh cycles is 1 C, for the eighth through tenth cycles is 2 C, and for the eleventh through thirteenth cycles is 3 C. Lastly, FIG. 7 likewise shows the capacity retention ratio 36 as a function of the number of cycles 34, but now for a full cell configuration, namely, three full cells including anodes made of SiNx, SiCx, and SiCxNy with the form factor 2032R.

Apart from the shell 14, previously described in detail, the particles 10 of the anode material 2 also have a core 12. In the example shown, the core 12 is made exclusively of carbon, which generally forms a framework for the shell 14 and holds and/or stabilizes it. The core 12 has an average diameter which is, for example, up to two orders of magnitude greater than the layer thickness D3 of the shell 14 and which results as the average value of the various diameters D4.

In addition, in the example shown here the particles 10 in each case have a casing 38 made of carbon in which the core 12 and the shell are enclosed 14. The core 12 is thus double-coated, with the shell 14 forming a first, inner layer and the casing 38 made of carbon forming a second, outer layer. The casing 38 directly adjoins the shell 14. The casing 38 is also used as filler material between the various shells 14 and spaces the shells apart from one another, as is clearly apparent from FIG. 1. The casings 38 of the particles 10 here are even grown and/or joined together, and then form a network in which the cores 12 with shells 14 are embedded, analogously to an individual particle 10 in which the nanoparticles 16 are embedded in its inactive matrix 18.

Various examples are conceivable for the particular form of the core and shell. In the present case, the shell 14 follows an outer contour of the core 12, and has essentially the same layer thickness D3 at each point. The shell 14 thus forms a uniform covering for the core 12. In addition, in the example shown here the core 12 and the shell 14 of a particular particle 10, taken together, have a plate-or rod-shaped design. However, a spherical shape of the core 12 and shell 14 is also possible in principle.

FIG. 8 shows an example of a method for producing the anode material 2. The shell 14 is produced in a chamber 40 by chemical vapor deposition (CVD), using a silicon-containing gas 42, a carbon-containing gas 44, and a nitrogen-containing gas 46. The silicon-containing gas 42 here is monosilane (SiH4). The carbon-containing gas 44 here is ethene (C2H4). The nitrogen-containing gas 46 here is ammonia (NH3). All three gases are applied at the same time, i.e., in a single method step, and in particular not separately or in different method steps.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An anode material comprising a plurality of particles, wherein a respective particle has a core and a shell surrounding the core, and wherein the shell contains silicon, carbon, and nitrogen.

2. The anode material according to claim 1, wherein the silicon in the shell forms a plurality of nanoparticles.

3. The anode material according to claim 2, wherein the nanoparticles have an average diameter in a range of about 0.5 nm to 5 nm.

4. The anode material according to claim 1, wherein the silicon in the shell together with the carbon and the nitrogen forms an inactive matrix in which the nanoparticles are embedded.

5. The anode material according to claim 4, wherein the inactive matrix is formed from a plurality of regions made of nitrogen-doped carbon, silicon nitride, silicon carbide, and silicon carbonitride.

6. The anode material according to claim 1, wherein the core is made exclusively of carbon.

7. The anode material according to claim 1, wherein the particles have a casing, made of carbon, in which the core and the shell are enclosed.

8. The anode material according to claim 1, wherein the core and the shell of the particle, taken together, have a plate-or rod-shaped design.

9. A battery that comprises an anode produced from an anode material according to claim 1.

10. A method for producing an anode material, the method comprising:
providing a plurality of particles, at least one of the particles has a core and a shell surrounding the core; and
producing the shell by gas phase deposition using a silicon-containing gas, a carbon-containing gas, and a nitrogen-containing gas.
